(19) United States
(12) Patent Application Publication
(10) Pub. No.: US 2002/0079301 A1
(43) Pub. Date: Jun. 27, 2002

(54) High deposition submerged arc welding system

(75) Inventors: William L. Bong, Walnut Creek, CA (US); Charles Bock, Vallejo, CA (US)

Correspondence Address: Michael A. Kerr, Virtual Legal, P.O. Box 2345, Stateline, NV, 89449, US

(73) Assignee: Arcmatic Integrated Systems, Inc., Vallejo, CA

(21) Appl. No.: 09/872,357

(22) Filed: May 31, 2001

Related U.S. Application Data
(60) Provisional application No. 60/223,836, filed on Aug. 8, 2000.

(51) Int. Cl. B23K 9/10; B23K 9/18

(52) U.S. Cl. 219/130.5; 219/125.1; 219/73

(57) ABSTRACT

The present invention relates to a high deposition submerged arc welding system, comprising a gantry fixture, a weldhead, an operator control module and a modular control system. The gantry fixture is configured to receive a first plate and a second plate. The weldhead is operatively coupled to the gantry fixture and welds the first plate and second plate together with a metal powder, a welding wire and a flux. The operator control module is configured to receive a program for welding the first plate and the second plate together. The modular control system has a common bus which communicates the program to a plurality of control modules.

### CROSS REFERENCES TO RELATED APPLICATIONS

This patent application does not cross reference any related applications.

### BACKGROUND OF THE INVENTION

1. Field of Invention

The present invention relates to a submerged arc welding system. More particularly, present invention is a submerged arc welding system for longitudinal heavy plate welds.

2. Description of Related Art

Steel fabrication industries have shown a need for obtaining higher deposition rates from the submerged arc welding process to improve economics of welding heavy plates and structural shapes. Additionally, for some time now there has been a need for a better method to reduce the cost for making longitudinal welds on beams and columns.

This need became more apparent when conventional, multi-pass, automatic, submerged arc welding procedures were used for welding heavier joints with depths ranging from ½ in. through 2 in. These conventional procedures require slag cleaning after each pass and a relatively large number of passes in order to maintain weld soundness and mechanical properties at a level commensurate with those properties commonly required by structural welding codes.

A faster method has been needed which could improve the economics for making these long welds on heavy plate. These longitudinal welds are generally one of four types: (1) horizontal fillet weld, (2) fully positioned fillet welds, (3) full penetration groove welds, or (4) partial penetration groove welds. These welds have traditionally been produced with either multipass submerged arc, or flux-cored wire welding processes (on plate thicknesses ranging from ½″ thick to 2″ thick). The drawbacks to a multipass weld is that it require slag cleaning after each pass and requires a relatively large number of passes to maintain weld soundness and mechanical properties at a level commensurate with those properties commonly required by structural welding codes.

### SUMMARY OF INVENTION

1. Advantages of the Invention

One of the advantages of the present invention is that it provides a system for reducing the cost of longitudinal welds on beams and columns.

A further advantage of the present invention is that it provides a single pass submerged arc welding system.

Another advantage of the present invention is that is provides a high deposition submerged arc welding system.

Another advantage of the present invention is that it is capable of producing a full penetration on one side of a plate within one single pass.

Another advantage of the present invention is that is generates a much smaller heat affected zone that other welding processes.

These and other advantages of the present invention may be realized by reference to other portions of the specification, claims, and abstract.

2. Brief Description of the Invention

The present invention relates to a high deposition submerged arc welding system, comprising a gantry fixture, a weldhead, an operator control module and a modular control system. The gantry fixture is configured to receive a first plate and a second plate. The weldhead is operatively coupled to the gantry fixture and welds the first plate and second plate together with a metal powder, a welding wire and a flux. The operator control module is configured to receive a program for welding the first plate and the second plate together. The modular control system has a common bus which communicates the program to a plurality of control modules.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Preferred embodiments of the present invention are shown in the accompanying drawings wherein:

FIG. 1 is substantially a cross-sectional side view of the high deposition submerged arc welding process.

FIG. 2 is substantially a front view of a twin carriage gantry for the high deposition submerged arc welding system.

FIG. 3 is substantially a side view of the a twin carriage gantry for the high deposition submerged arc welding system.

FIG. 4 is substantially a block diagram of the control system for the high deposition arc welding system.

FIG. 5 is substantially a front view of the operator control manual.

### DESCRIPTION OF THE PREFERRED EMBODIMENT

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made with out departing from the scope of the present invention.

The present invention provides a system to improve the welding economics for longitudinal heavy plate welds, while still maintaining quality. The present invention is a high deposition submerged arc welding system. Preferably, the system uses metal power and two wires to generate a single arc.

The High Deposition Submerged Arc Welding Process

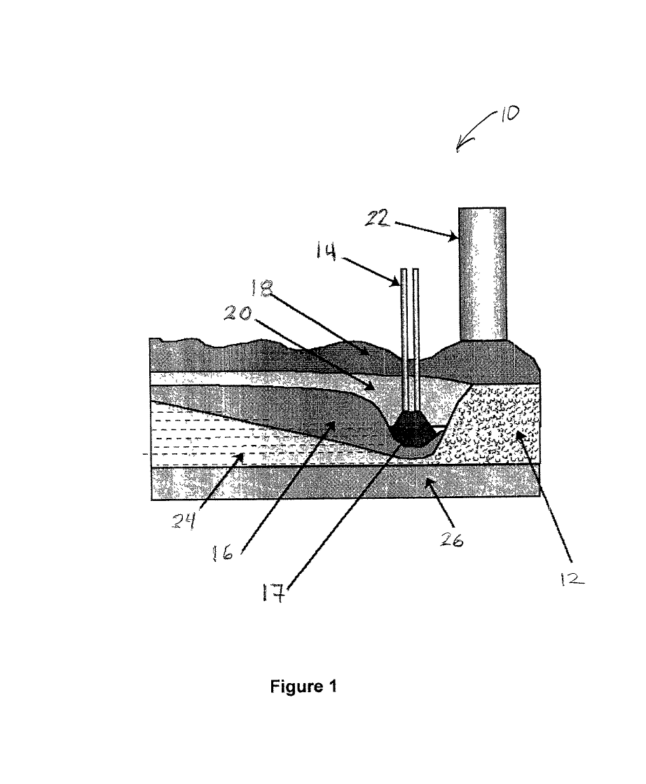

Referring to FIG. 1 there is shown a cross sectional view of the high deposition submerged arc welding process 10. The high deposition submerged arc welding system uses an atomized metal powder (AMP) 12 and two welding wires 14 to generate molten weld metal 16 which fuses two substrates. For illustrative purposes, the two welding wires 14 travel from left to right during the welding of the two substrates. Additionally, the two welding wires 14 carry a high current which generates a welding arc 17 that melts the welding wires 14 and melts a flux 18 to generate a molten flux 20 which prevents oxidation to the molten weld metal 16. A flux tube 22 deposits the flux 18 on the AMP 12. The molten weld metal 16 cools and becomes solidified metal 24. A back up bar 26 is used to hold the two substrates together during the high deposition submerged arc welding process.

Preferably, the parameters for generating the welding arc 14 achieve the maximum penetration through the AMP 12 into the backup bar 26. The flux tube 22 covers the welding area as in conventional submerged arc welding. A relatively high current is applied to the two welding wires 14. The molten flux 20 following the weld arc 17. Preferably, the two welding wires 14 are two 3/32″ diameter or two ⅛″ diameter welding wires and carry currents up to 2000-amps in a single arc. This high amperage allows the process to achieve the deep penetration necessary for single pass welding. In operation, the high deposition welding system produces a full penetration weld on plate (up to 1½″ thick) in one single pass on one side of the substrate.

Weld quality and productivity is with the present invention provides a higher welding current which is applied to the dual wires completely melts the iron powder to the full depth of the weld joint. The majority of the heat produced by the high current is used to melt the AMP and not the substrates. Additionally, the two welding wires 14 and the AMP 12 forms a molten puddle composed of 60% weld wire and 40% AMP. The molten weld metal 16 can remain molten from 6 to 12 inches behind the welding arc. The heat from the molten weld metal 16 causes the walls of the weld joint to melt. When the molten weld metal 16 solidifies, it forms the resultant weld nugget. The AMP 12 absorbs most of the heat from the welding arc which reduces the amount of heat available to be absorbed by the parent material as Heat Affected Zone (HAZ), thereby resulting in a much smaller HAZ than other high current welding processes. Additionally, the higher current required by the high deposition submerged arc welding system increases deposition rates more than 100% over conventional submerged arc processes. Deposition rates of 100 lbs. to 190 lbs. per hr. are typically realized in production welding.

Using the high deposition submerged arc welding system production welds have been made to structural steel beams and columns, ranging in thickness from ⅜-in. to 4-in. Weld lengths typically range from 1-ft. to over 60-ft.

Applications for High Deposition Submerged Welding

A number of welding applications are suited for high deposition submerged arc welding. These welding applications include shipbuilding, building fabrication, manufacturing of heavy machinery, bridges and vessels.

For shipbuilding applications the high deposition submerged arc welding system may be used for one-side welding, two-side welding and three member tie-in welds. One side welding may be accomplished with a gantry fixture described in further below. Backing systems may include permanent copper bars or systems using flux on bars. For erection joints, tape may be used in some applications. Cost savings are generally possible with the increased deposition rates and reduced repair possible when AMP is used. Two-side welding may be done in panel shops having crane facilities for plate turn over. Backing bars are not generally required. Cost savings are possible through higher travel speeds or a reduced number of passes. Three member tie-in welds are done in panel shops primarily. The third member acts as a steel backing bar for a butt weld. Advantages of using the high deposition submerged arc welding system includes a reduction of welding passes and excellent tolerance to joint gap variation for three member tie-in weld.

For building fabrication applications partial-penetration, full-penetration and fillet welds are commonly used in structural steel and building fabrication. Partial-penetration welds are commonly used on such items as heavy box columns, angles and other fabricated shapes. The advantages of the high deposition submerged arc welding system include a increased productivity and having few repairs. Full-penetration welds may be required on some box-column applications and for joining large plates. The principal advantage of using iron powder is to obtain increases in productivity.

For heavy machinery applications, two-side, full-penetration and fillet welds are commonly employed for heavy machinery and motor housings. The advantage of the high deposition submerged arc welding system is the reduction in the number of weld passes or the considerable decrease in actual welding time.

For bridges and vessels, full-penetration welds are used primarily on these items. Single pass welds may be used on general applications requiring ordinary toughness values above 0° F. Multipass welds would normally be used for applications requiring toughness at reduced temperatures or for applications where multipass welds are specifically called for by a code. The high deposition submerged arc welding system generates a high deposition rate and effectively reduces the heat input for a given welding current, voltage and travel speed condition. There are numerous other applications throughout the welding industry for conducting horizontal or flat position fillet welds with the high deposition submerged arc welding system.

The Gantry

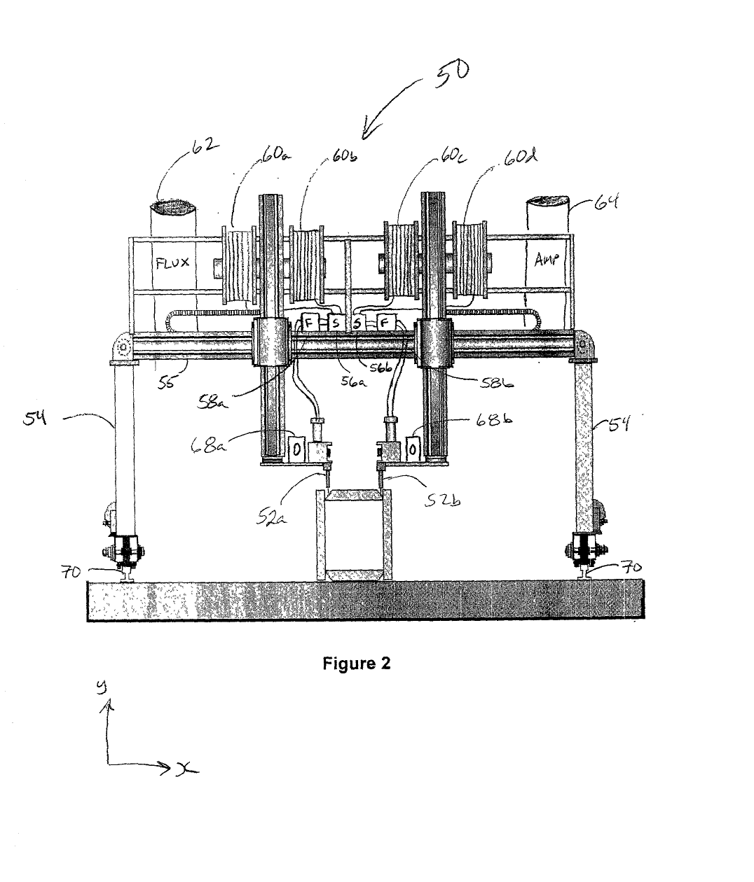

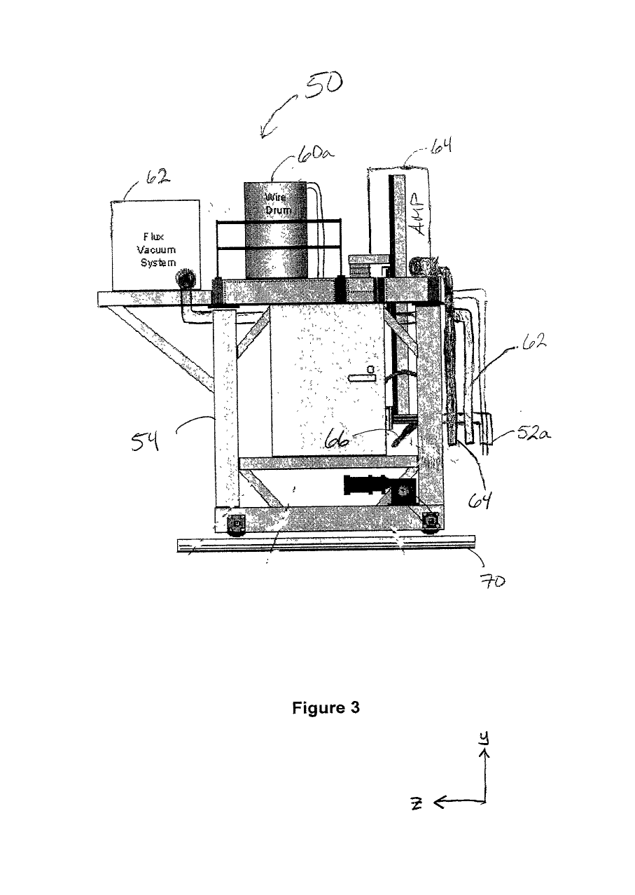

FIG. 2 is substantially a front view of a twin carriage gantry 50 for the high deposition submerged arc welding system having a plurality of plates to weld. FIG. 3 is substantially a side view of the twin carriage gantry 50 without the plurality of plates. Referring to both FIG. 2 and FIG. 3, a detailed description of the gantry 50 is provided herewith. Preferably, the gantry 50 is equipped with two weld heads 52a and 52b which are used for heavy structural steel fabrication. The gantry 50 comprises a gantry fixture 54 having a carriage 55 which is operatively coupled to the weld heads 52a and 52b, two wire straighteners 56a and 56b, two wire feed module 58a and 58b, a plurality of wire drums 60a, 60b, 60c and 60d, a wire guide assembly (not shown), a flux system 62, an AMP fill system 64, a seam tracking element 66, and two oscillation modules 68a and 68b.

The gantry fixture 54 includes a frame which is configured to traverse a weld seam for workpieces having at least a first plate and a second plate along a track 70. The gantry fixture 54 includes a carriage 55 which permits motion of each weldhead 52a and 52b relative to the workpieces. As shown in FIG. 2, the carriage 55 allows for motion of each weldhead along the x-axis and along the y-axis. As shown in FIG. 3, the gantry fixture 54 is configured to travel along the z-axis. Additionally, a table (not shown) may be provided for the workpieces to rest upon. Preferably, the gantry fixture 54 is custom designed and fabricated for specific job applications requirements. By way of example, the gantry fixture is 14 ft. wide×9 ft. length×11 ft. high.

The carriage 55 of the gantry fixture 54 supports weldheads 52a and 52b and is configured to provide movement of the weldheads along the carriage 55. The gantry fixture 54 provides constant travel motion along the joint being welded. The carriage 55 is also configured to provide for reasonably adjustment of the distance between the weldheads and the workpiece, the weldhead lead and approach angles, tracking of the weldhead, and spacing between the weldheads 52a and 52b. It shall be appreciated by those skilled in the art that either the weldheads 52a or 52b or the workpiece may be moved to provide travel motion depending on the most feasible design approach.

The two wire straightener 56a and 56b are mounted on the gantry 54. Preferably, four roller-guides direct the welding wire from the drums 60a through 60d into the input of each of the two wire straightener 56a and 56b. Each two wire straightener simultaneously removes cast and helix from both solid and metal-cored wires. Preferably, each two wire straightener handles two wires, up to ⅛″ in diameter. Welding wire is pulled from a drum to the rotary straightener. As wire passes through the rotor, it has both cast and helix. Helix in the wire continually changes the cast direction with regard to the rotor. Since the rotor continually rotates around the wire, it counter-bends the cast, no matter which direction helix in the wire places the cast. In this way, the rotor removes both cast and helix from the wire. An illustrative wire straightener is shown in patent application ______ titled ______. Each of the two wire feed modules 58a and 58b are capable of supplying wire at rates from 40 in/min to 100 in/min. Preferably, a four roll drive system transmits force into the wire for positive feeding. Each of the two wire feed modules 58a and 58b are configured to pass 3/16 in, 7/32 in, or ¼ inch in diameter wires as required by the current used in a specific application. It shall be appreciated by those skilled in the art that wire straightening would be applied for most applications. An more detailed description of an illustrative wire feeder is described in patent application ______ titled ______.

The wire guide assembly (not shown) is configured to transfer the welding wire from the wire drum to the weld head. It shall be appreciated by those skilled in the art that a variety of wire guide assemblies are well known.

The flux system 62 dispenses flux for the submerged arc welding system. The flux system 62 delivery occurs 1 in. ahead of the arc from welding wire fed through weldhead 52a and 52b. Preferably, the delivery system has a sufficiently high flow rate to provide 2-in. flux bed at travel speeds up to 50 in. per mm. Preferably, a 1-in. diameter hose is used to pass the flux at this flow rate. About 50 cu. in. of flux is required per ft. of weld. Preferably, a flux recovery vacuum system (not shown) is used, and follows the arc by about 12 inches. Preferably, two Weld Engineering, Model “Mighty-Mac-1500”, heavy-duty flux recovery systems are employed as the flux delivery systems for the gantry.

Preferably, the AMP fill system 64 dispenses AMP. Alternatively, the AMP can be added either by hand or by an automatic metal powder dispenser, similar to that used for dispensing flux. A weld joint level full of AMP is desired and a simple leveling device on the bottom is used where automatic application is required. The quantity of AMP required depends on joint thickness and weld length. Typically 10 cu. in. per ft. of weld would be required for a 1½ in. full-penetration joint level filled.

The seam tracking element 66 is needed to guide the weldhead along the joint being welded. Production welding joints have proven to require seam tracking. Preferably, the welding wires are centered within an approximate +1/32 in. deviation from the centerline of the joint. Various well known electronic and mechanical seam tracking devices may be used.

Each of the oscillation module 68a and 68b are used when the top joint width exceeds approximately ¾ in.. Oscillation is preferably used to adequately spread the width of the weld bead. Oscillation speed is generally five times faster than the travel speed. The oscillation distance should be approximately ½ of the total joint width. Width, speed, dwell, and centerline of oscillation are set at the operator's control panel.

A power source (not shown) transfers power to the welding wires. Preferably, the power source comprises two or three direct current (DC) 1000-Amp, 100% duty cycle, constant-voltage power sources which are operatively coupled in a parallel arrangement to provide 2000 or 3000-Amps of welding current capacity. Additionally, a water pump (not shown) may be used to transfer heat from the molten weld puddle generated during high deposition submerged arc welding system.

Consumables

Consumables are the filler materials for the high deposition submerged arc welding system. The consumable include flux, welding wire, AMP and any alloy additions. Successful practice of this method of welding requires that all of the components be formulated for compatibility. Actual test results with Arcmatic filler materials meet the requirements of American Welding Society Specification D1.1, Welding Procedure Qualification and have been approved by the American Bureau of Shipping.

The flux composition and flux sizing have a considerable influence on arc behavior and finished weld appearance. The main factors that were considered in developing a flux were: ease of slag removal, arc stability, mechanical properties, flux feed ability, minimum flux consumption and bead appearance. As a result of this development program, specific flux composition was formulated for optimum overall performance. The flux is the Arcmatic MMF-70. Actual flux consumption tests indicated that approximately 0.5-lbs. of flux was required per lb. of weld deposit. This is a considerable improvement over conventional multipass submerged arc welding where typically 1.0 to 1.5-lbs. flux is required per lb. of weld deposit. Generally a 2 in. flux bed depth was found to be optimum for stable arc conditions with either single or tandem arc operation. After exhaustive research, it was found that fused fluxes provided much greater arc stability at amperages up to 2000-Amps. The Arcmatic MMF-70 is a medium manganese-oxide fused flux for welding mild steels, and high tensile strength steels that are used in bridges, steel frame buildings, and ships. Additionally, the medium manganese oxide flux is used in conjunction with the welding wire described below.

The type of welding wire used for the high deposition submerged arc welding system includes the type EM-12K and EG-14 welding wires. The EM-12K wire is a medium manganese welding wire and EH-14 is a high manganese welding wire. The medium manganese wire typically provides good results on structural steels. When higher strengths and toughness are required, EG-14 is generally recommended.

Preferably, the AMP used is the Arcmatic AMP-525 Joint Fill. This AMP has a uniform particle size and homogeneous chemical analysis. It is produced by “atomization” which involves breaking a stream of molten iron into very small particles by means of fluid jets, aimed at the stream. Some refining of the metal can be done prior to atomizing so refining of the molten iron through the proper choice of raw materials and melting practice can control the impurity content of the iron powder. The iron powder produced by this system has very low porosity and the particles are roughly spherical in shape. Since a portion of the arc energy is needed to melt the iron powder, welds produced using this method generally show a reduced effective welding heat input at similar currents. This reduced heat input can be expected to contribute to better mechanical properties, especially toughness in the heat affected zone.

Additionally, a small alloy addition of nickel has been used to provide some additional toughness, in addition to that obtainable with manganese alone. This specific composition has been found to give optimum weld deposit properties when used with a medium manganese welding wire. With normal dilution the weld deposit usually contains 0.4% Ni and 1.0% Mn.

Using the consumables described with the EM-12K wire in the high deposition submerged arc welding system generates an ultimate tensile strength of about 80,000 psi to 85,000 psi. This ultimate tensile strength is well over the 70,000 psi tensile strength which are widely used in buildings, bridges, ships, heavy machinery and earth moving equipment. Additionally, the yield strengths using the EM-12K welding wire are approximately 53,000 psi to 65,000 psi which is above the 50,000 psi desired as a minimum. Typically, elongations are usually over 26%, which is well over base steel or weld metal requirements of 21% or 22%, respectively. CVN impact values typically average 15 ft-lbs to 20 ft-lbs at −20° F. or 30 ft-lbs to 36 ft-lbs at 20° F. Expected values at 0° F would be in the mid twenties on A-441 steel. On ABS Grade C steel the properties are similar to the above except the impact properties were taken at 32° F. with an average of 38 ft-lbs CVN. On other steels most properties will be similar except impacts may deteriorate with lower quality base steels. Deposits typically contain about 0.10% carbon, 1.00% manganese, 0.40% silicon and 0.40% nickel. Residuals of phosphorus and sulfur are usually 0.015%. A small amount of molybdenum, about 0.08% is usually present. The balance is the element iron. Hot and Cold cracking are minimized by maintaining low carbon, phosphorus and sulfur levels. Manganese, nickel and silicon are the principal strengtheners with a slight possible contribution from molybdenum. Nickel contributes to improved impact performance.

Generally, fabricators have thought that welds made with high heat inputs caused more distortion than welds made with low heat-inputs. However, actual tests show that distortion is closely related to other factors such as the presence of iron powder which makes single pass welding practical and the solidification pattern resulting from a single pass weld.

In a test performed by the inventors, two comparison welds were tested. The first weld was completed with 10 passes of conventional welding using no iron powder and a single arc. The heat input was calculated to be 84,000 joules per in. for each pass. A second weld was made with the single pass system, using AMP-525. The heat input was calculated to be 316,000 joules per inch. It is interesting to note that the gross heat input for conventional welding with 10 passes is 840,000 joules per inch or almost three times that required for single pass welding with AMP-525. Total distortion was considerably less for the single pass weld with iron powder even though a higher heat input was used on a per pass basis.

The Control System

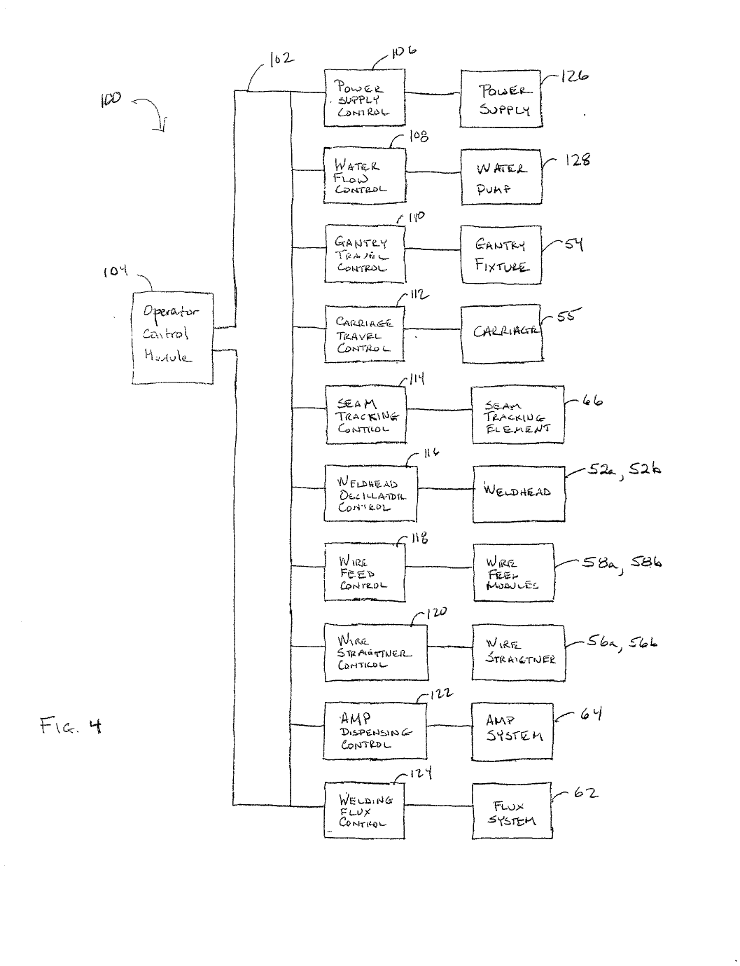

FIG. 4 is a block diagram of the control system for the high deposition arc welding system. Preferably, the control system for the high deposition submerged arc welding system is a distributed control system having a plurality of control modules which share a common bus 102. In the preferred embodiment the common bus 102 is a 6-conductor bus which communicates control signals to all the control modules in the system. It shall be appreciated by those skilled in the art having the benefit of this disclosure that the maintenance of the control system is simplified by having the plurality of control modules operate which can be easily replaced.

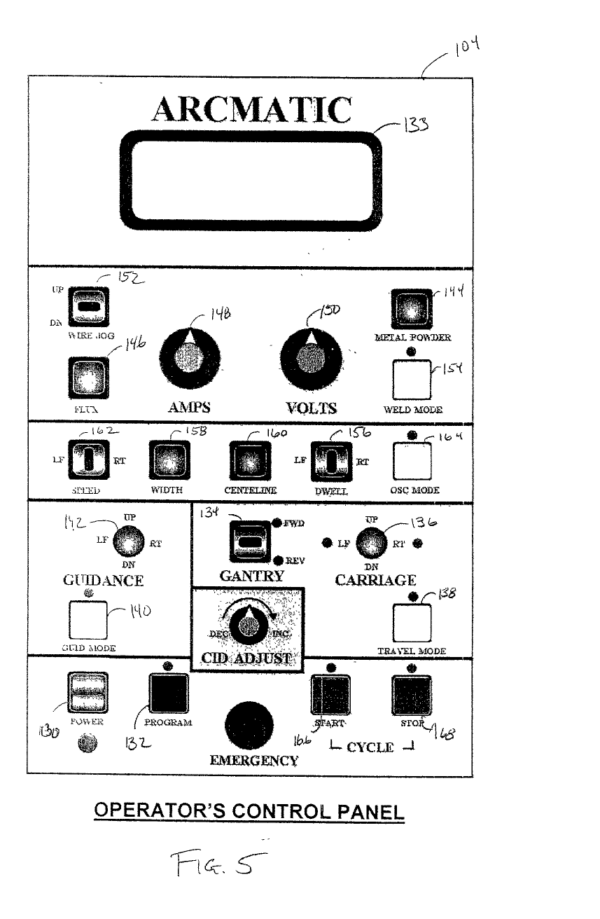

The control system is managed by an operator control module 104 which is operatively coupled to the common bus 102. The operator control module generates the operating parameters for each of the plurality of control modules. The operator control module provides an interface for the operator to communicate operating parameter to each of the plurality of control modules. The operating parameters may be pre-programmed or may be programmed by the operator. The operator control module 104 is described in further detail below in the discussion of FIG. 5.

Preferably, the operator control module is in communication with a power supply control module 106, a water flow control module 108, a gantry travel control module 110, a carriage travel control module 112, a seam tracking control module 114, a weldhead oscillator control module 116, a wire feed control module 118, a wire straightener control module 120, an AMP dispensing module 122, and a welding flux control module 124. The power supply control module 106 regulates a power supply 126. The water flow control module 108 controls a water pump 128. The gantry travel control module 110 manages the movement of the gantry fixture 54 along the track 70 (see FIG. 2 and FIG. 3). The carriage travel control module 112 controls the movement of the carriage 55 which carries the weldheads 52a and 52b. The seam tracking control module 114 is in communication with the seam tracking element 66 which travels along the centerline of the weld joint. The weldhead oscillator control module 116 manages any oscillations of the weldheads 52a and 52b. The wire feed control module 118 is in communication with the wire feed modules 58a and 58b which feed welding wire to the weldhead. The wire straightener control module 120 is in communication with wire straighteners 56a and 56b which remove cast and helix from the welding wire drawn by the wire feed modules 58a and 58b. The AMP dispensing control module 122 communicates with the AMP system 64 which deposits the optimal amount of AMP in the joint. The welding flux control module 124 manages the flux system 62 which deposits the optimal amount of flux on the AMP during the submerged arc welding process.

Each of these control modules receive operating parameters from the operator control module 104 shown in FIG. 5. The operator control module is engaged by turning the power switch 130. After being switched on the operator control module system boots up and a system check is initiated in which checks are submitted to the water flow module, the welding power supply module, the wire straightener module, the wire feeder control module, oscillator control module and the operator control module.

Once the operator control module 104 is activated, the operator presses the program/weld mode switch 132. A plurality of program screens are displayed on display 133. Preferably, the program screen include pre-weld conditions, seam tracking conditions, weld travel conditions, metal powder dispensing conditions, initial weld conditions, initial oscillation conditions, program weld conditions, program oscillation conditions, final weld conditions, final oscillation conditions, and post weld conditions. The operator enters the appropriate weld program information using the interface provided by the operator control panel 104.

To start a weld the operator must position the weldhead in the proper location. To do this the operator initiates gantry motion control along the z-axis (see FIG. 3) with switch 134. Carriage motion control along the y-axis and x-axis (see FIG. 2) is accomplished with joystick 136. The gantry motion control and carriage motion control are engaged with button 138. Seam tracking control is engaged with button 140 and the seam tracking module is controlled with joystick 142. The seam tracking module is placed along the centerline of the weld seam.

After the welding operator has positioned the weldhead over its start position, the operator uses the jog button on the metal powder dispenser 144 to jog metal powder to the weld seam. Then the operator will use jog button 146 to dump flux over the metal powder. The operator then begins the weld. The programmed operating parameters are then communicated to the plurality of control modules.

During the process of programming the operator control module, the amperage dial 148 and voltage dial 150 are used to input information for the welding power supply. The wire jog button 152 is principally used to feed welding wire to the weld head and thereby ensure that there are no obstructions in the path of the welding wire. The weld mode button 154 is used to program the type of weld being performed. Oscillation control is provided with the dwell switch 156, width button 158, centerline button 160, speed switch 162, and oscillation mode button 164. Cycle start button 166 and cycle stop button 168 engage and terminate the program, respectively.

Operation with Various Joints

The high deposition submerged arc welding system can be applied to a variety of different welding joints. Generally, applications are in the flat welding position. Joint designs include fillet, square-edge, single “V” and double “V”. The “V” joints may have single or double bevels depending on production requirements. Generally, a single bevel joint is used where two main members are to be welded together at right angles to each other, such as box-column fabrication. The double bevel is used for butt welds.

As a general rule, joint designs will have a square-edge preparation for thicknesses from ⅜ in. to ⅝ in. Preferably, a single “V” preparation with 30° included angle is generally used from ⅝ in. to 2-in. thickness. A double bevel preparation may be used for thicknesses from 2-in. to 4-in., using a two-pass, two-wire welding procedure. Most joints thinner than 1½in. are designed for single-pass welding from one side only. Joints beyond 4-in. total thickness may be welded using a combination of conventional multipass technique in the root, followed by a single, high-current capping pass with the iron powder for the final 2 in. layer on each side of the joint.

Other joint designs may be required in some specific applications. For example, a seal pass may be required on partial-penetration joints in order to prevent the large molten weld puddle from draining through gaps. A flux cored or shielded metal arc weld pass may be used to seal the joint bottom. For accessibility a 40° or 45° included angle may be required when sealing must be done. These wider angles may be required for multipass welding applications.

It shall be appreciated by those skilled in the art that with the preferred joint angle of 30° is substantially a smaller angle than the conventional 45° used for multipass welding. This preferred joint angle 30° reduces the amount of filler material by 42%.

A number of back-up systems may be used with these joint designs. In single-pass welding from one side, it is possible to use steel, copper, a combination of flux and copper or tape back-up systems. Steel back-up bars are generally used where code requirements are such that the steel can be left in position after the weldments are completed. The copper or copper flux systems are generally applied where smoothly contoured underside bead reinforcement is desired in the as welded condition. This would be most useful in situations where a permanently attached back-up bar is not allowed. A tape system might be used in areas having no backside accessibility or in field welding where a more complex back-up system is not feasible. Most production work to date has been done on steel backup bars.

The high deposition submerged arc welding system has very high deposition rate capabilities which reduce welding costs compared to other methods of welding. Additionally, once the welding procedure is established, the quality of the weld remains constant throughout the weld, eliminating random rejections and costly repairs.

### CONCLUSION

The automated welding for the high deposition submerged arc welding system requires that the welding variables be clearly defined and controlled. When making single pass welds, the recommended welding wire must be used in conjunction with the recommended welding flux and AMP. Additionally, during a weld run a sophisticated control system is needed to manage and regulate the power consumption used in the weld run and to manage and control the wire position and wire feed during the weld run. The high deposition submerged arc welding system manages welding variables during the weld run and thereby guarantees a quality, high deposition weld.

Although the description above contains many specifications, these should not be construed as limiting the scope of the invention but as merely providing illustrations of some of the presently preferred embodiments of this invention. The specification, for instance, makes reference to bonus prizes. However, the present invention is not intended to be limited to bonus prizes. Rather it is intended that the present invention can be used independently as a stand-alone game. Thus, the scope of the invention should be determined by the appended claims and their legal equivalents rather than by the examples given.

What is claimed is:

1. A high deposition submerged arc welding system, comprising:
a gantry fixture configured to traverse a first plate and a second plate;
a weldhead operatively coupled to said gantry fixture, said weldhead configured to weld said first plate and said second plate together with a metal powder, a welding wire and a flux;
an operator control module configured to receive a program for welding said first plate and said second plate; and
a modular control system having a common bus which communicates said program to a plurality of control modules.

2. The high deposition submerged arc welding system of claim 1 wherein said weld head is configured to receive at least two wires configured to generate a single arc.

3. The high deposition submerged arc welding system of claim 2 wherein said at least two wires are configured to carry current up to 2000 amps.

4. The high deposition submerged arc welding system of claim 1 further comprising a welding power supply control module configured to control a welding power supply.

5. The high deposition submerged arc welding system of claim 1 further comprising a wire feeder configured to feed welding wire to said weldhead.

6. The high deposition submerged arc welding system of claim 5 further comprising a wire feeder control module configured to control said wire feeder.

7. The high deposition submerged arc welding system of claim 1 further comprising a wire straightener configured to straighten wire fed to said weldhead.

8. The high deposition submerged arc welding system of claim 7 further comprising a wire straightener control module configured to control said wire straightener.

9. The high deposition submerged arc welding system of claim 1 further comprising an oscillator configured to oscillate said weldhead.

10. The high deposition submerged arc welding system of claim 9 further comprising a ocillator control module configured to control said oscillator.

11. A high deposition submerged arc welding system, comprising:
a gantry fixture configured to traverse a first plate and a second plate;
a weldhead operatively coupled to said gantry fixture, said weldhead configured to receive at least two wires to generate a single arc to weld said first plate and said second plate together with a metal powder, a welding wire and a flux;
an operator control module configured to receive a program for welding said first plate and said second plate; and
a modular control system having a common bus which communicates said program to a plurality of control modules.

12. The high deposition submerged arc welding system of claim 1 1 wherein said at least two wires are configured to carry current up to 2000 amps.

13. The high deposition submerged arc welding system of claim 12 further comprising a welding power supply control module configured to control a welding power supply.

14. The high deposition submerged arc welding system of claim 13 further comprising a wire feeder configured to feed welding wire to said weldhead.

15. The high deposition submerged arc welding system of claim 14 further comprising a wire feeder control module configured to control said wire feeder.

16. The high deposition submerged arc welding system of claim 15 further comprising a wire straightener configured to straighten wire fed to said weldhead.

17. The high deposition submerged arc welding system of claim 16 further comprising a wire straightener control module configured to control said wire straightener.

18. The high deposition submerged arc welding system of claim 17 further comprising an oscillator configured to oscillate said weldhead.

19. The high deposition submerged arc welding system of claim 18 further comprising a ocillator control module configured to control said oscillator.

20. A high deposition submerged arc welding system, comprising:
a gantry fixture configured to traverse a first plate and a second plate;
a weldhead operatively coupled to said gantry fixture, said weldhead configured to receive at least two wires to generate a single arc to weld said first plate and said second plate together with a metal powder, a welding wire and a flux;
an operator control module configured to receive a program for welding said first plate and said second plate;
a modular control system having a common bus which communicates said program to a plurality of control modules; and
a welding power supply control module configured to control a welding power supply.
